(19) United States
(12) Patent Application Publication
(10) Pub. No.: US 2026/0279763 A1
(43) Pub. Date: Sep. 17, 2026

(54) ELECTRODE ASSEMBLY FOR SECONDARY BATTERIES AND METHOD OF MANUFACTURING THE ELECTRODE ASSEMBLY

(71) Applicant: SAMSUNG SDI CO., LTD., Yongin-si (KR)

(72) Inventor: Hyun Woo KIM, Yongin-si (KR)

(21) Appl. No.: 19/298,429

(22) Filed: Aug. 13, 2025

(30) Foreign Application Priority Data
Mar. 14, 2025 (KR) 10-2025-0033173

(51) Int. Cl. H01M 4/13; H01M 4/04; H01M 4/139; H01M 10/0525; H01M 10/0565; H01M 10/058

(52) U.S. Cl. CPC H01M 4/13; H01M 4/0471; H01M 4/139; H01M 10/0525; H01M 10/0565; H01M 10/058; H01M 2300/0082

(57) ABSTRACT

An electrode assembly includes a first electrode including a first current collector and a first active material layer provided on the outside of the first current collector, the first electrode being a columnar shape. The electrode assembly also includes a second electrode including a second current collector and a second active material layer provided on the outside of the second current collector, the second electrode being provided with a mounting hole configured to receive the first electrode therein, the second electrode extending to a length corresponding to the first electrode. An electrolyte layer is disposed between the first electrode and the second electrode, the electrolyte layer including a curable electrolyte.

### CROSS-REFERENCE TO THE RELATED APPLICATION

The present application claims priority to and the benefit of Korean Patent Application No. 10-2025-0033173, filed on Mar. 14, 2025, in the Korean Intellectual Property Office, the entire disclosure of which is incorporated herein by reference.

### BACKGROUND

### 1. Field

Embodiments of the present disclosure relate to an electrode assembly for secondary batteries and a method of manufacturing the electrode assembly.

### 2. Description of the Related Art

Unlike a primary battery that cannot be charged, a secondary battery is a rechargeable and dischargeable battery. A low-capacity secondary battery may be used for various portable small-sized electronic devices, such as a smartphone, a feature phone, a notebook computer, a digital camera, or a camcorder, and a high-capacity secondary battery is widely used as a power source for motor drives, such as those in hybrid vehicles or electric vehicles. The secondary battery includes an electrode assembly consisting of a positive electrode and a negative electrode, a case accommodating the same, and electrode terminals connected to the electrode assembly.

The above information disclosed in this Background section is only for enhancement of understanding of the background of the invention and therefore it may contain information that does not constitute prior art.

### SUMMARY

Embodiments of the present disclosure provide a secondary battery configured such that the structure of an electrode assembly of the secondary battery is improved, whereby the problems related to maintenance of distance and alignment between the electrodes are solved, and therefore the reliability of a manufacturing process and battery performance are improved.

Embodiments of the present disclosure provide a secondary battery configured such that the structural strength and electrical connection efficiency of an electrode assembly are improved through a new manufacturing process using electrical discharge machining and a curable electrolyte, and the current density between electrodes is equalized, whereby battery life and charging and discharging efficiency are improved.

However, the technical problems to be achieved in the embodiment of the disclosure are not limited to the technical problems mentioned above, and other technical problems not mentioned herein will be clearly understood from the following description by those skilled in the art to which the disclosure belongs.

An exemplary electrode assembly for secondary batteries according to an embodiment of the present disclosure to accomplish the above objects includes a first electrode including a first current collector and a first active material layer provided on an outside of the first current collector, the first electrode being a columnar shape, a second electrode including a second current collector and a second active material layer provided on an outside of the second current collector, the second electrode being provided with a mounting hole configured to receive the first electrode therein, the second electrode extending to a length corresponding to the first electrode, and an electrolyte layer disposed between the first electrode and the second electrode, the electrolyte layer including a curable electrolyte.

In some examples, the first electrode may be one of a positive electrode and a negative electrode, and the second electrode is one of a positive electrode and a negative electrode that is opposite to the first electrode.

In some examples, the first electrode and the second electrode may be coupled to each other with a set distance being maintained between the first electrode and the second electrode.

In some examples, the set distance may be 0.1 mm to 3 mm.

In some examples, the first electrode and the second electrode may have the same height.

In some examples, each of the first electrode and the second electrode may have a height of 1 mm to 10 cm.

In some examples, the electrolyte layer may be formed from a curable electrolyte including an oxazoline-based material.

In some examples, the electrolyte layer may further include a lithium salt.

In some examples, electrolyte layer may be in a liquid state before curing and may turn to a solid state during a curing process.

In some examples, the first electrode may include a plurality of columns arranged at uniform intervals.

In some examples, the first electrode may include a plurality of prisms arranged in a matrix form.

In some examples, the second electrode may include a single column formed in a lattice shape, and the mounting hole may be provided in the second electrode.

In some examples, the second electrode includes a plurality of the mounting hole, and each of a plurality of columns of the first electrode may be inserted into one of the mounting holes.

An exemplary method of manufacturing an electrode assembly for secondary batteries according to an embodiment of the present disclosure to accomplish the above objects includes forming a first electrode including a first active material layer provided on the outside of a first current collector, the first electrode being formed as a plurality of columns, forming a second electrode including a second active material layer provided on the outside of a second current collector, the second current collector being a columnar shape, with a plurality of holes being formed in the second electrode, inserting each of the columns of the first electrode into a corresponding one of the mounting holes of the second electrode to couple the first electrode and the second electrode to each other, and filling the space between the first electrode and the second electrode with a curable electrolyte to form an electrolyte layer.

In some examples, each of the first electrode and the second electrode may be formed by electrical discharge machining.

In some examples, each of the first electrode and the second electrode may be formed by a ceramic sintering process.

In some examples, the columns of first electrode are arranged at uniform intervals in the second electrode.

In some examples, the second electrode may include a single column formed in a lattice shape, and the mounting holes may be provided in the second electrode.

In some examples, each of the columns of the first electrode and a corresponding one of the mounting holes of the second electrode may engage with each other.

In some examples, the electrolyte layer may include a curable electrolyte.

### BRIEF DESCRIPTION OF THE DRAWINGS

The following drawings attached to this specification illustrate preferred embodiments of the present disclosure and serve to further understand the technical idea of the present disclosure together with the detailed description of the present disclosure, and thus, the present disclosure should not be construed as being limited to the matters described in such drawings.

FIG. 1 is an exploded perspective view of an electrode assembly for secondary batteries according to an embodiment of the present disclosure;

FIG. 2 is a perspective view of an assembled electrode assembly for secondary batteries according to an embodiment of the present disclosure;

FIG. 3 is a plan view of an electrode assembly for secondary batteries according to an embodiment of the present disclosure;

FIG. 4 is a front view showing an exploded state of an electrode assembly for secondary batteries according to an embodiment of the present disclosure;

FIG. 5 is a perspective view of a secondary battery according to an embodiment of the present disclosure;

FIG. 6 is an exploded perspective view of an electrode assembly for secondary batteries according to an embodiment of the present disclosure;

FIG. 7 is a perspective view of an assembled electrode assembly for secondary batteries according to the other embodiment of the present disclosure;

FIG. 8 is a plan view of an electrode assembly for secondary batteries according to an embodiment of the present disclosure;

FIG. 9 is a flowchart showing a method of manufacturing an electrode assembly for secondary batteries according to an embodiment of the present disclosure;

FIGS. 10 and 11 are perspective views showing a battery pack including an exemplary secondary battery according to the present disclosure; and

FIGS. 12 and 13 are a perspective view and a side view, respectively, showing a vehicle including an exemplary battery pack according to the present disclosure.

### DETAILED DESCRIPTION OF EXEMPLARY EMBODIMENTS

Hereinafter, the present disclosure will be described in detail. Prior to giving the following detailed description of the present disclosure, it should be noted that the terms and words used in the specification and the claims should not be construed as being limited to ordinary meanings or dictionary definitions but should be construed in a sense and concept consistent with the technical idea of the present disclosure, on the basis that the inventor can properly define the concept of a term to describe the disclosure in the best way possible. Therefore, the embodiments described in the specification and the configurations described in the drawings are only the most preferred embodiments of the present disclosure, and do not represent all of the technical ideas of the present disclosure. It is to be understood that there may be various equivalents and variations in place of them at the time of filing the present application. In addition, as used herein, the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof. In addition, when describing embodiments of the present disclosure, “can” and “may” may include “one or more embodiments of the present disclosure.”

In addition, for a better understanding of the invention, The attached drawings are not drawn to scale and the dimensions of some components may be exaggerated. In addition, the same reference numbers may be assigned to the same components in different embodiments.

A reference to two objects in comparison being the same means that they are substantially the same. Thus, the wording “substantially the same” may include cases where the same is considered to be a low level in the related art, for example, a deviation within 5%. In addition, when any of parameters is referred to as being uniform in a given region, it may mean that the parameter is uniform from an average perspective.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, unless otherwise defined, a first element, component, region, layer or section described below could be termed a second element, component, region, layer or section, without departing from the spirit and scope of the present disclosure.

Throughout the specification, each component may be singular or plural, unless the context clearly indicates otherwise.

The arrangement of an arbitrary component on the “upper portion (or lower portion)” or “upper (or lower) portion” of a component means that an arbitrary component is placed in contact with the upper (or lower) surface of the component. In addition, it may mean that other components may be interposed between the component and any component disposed on (or under) the component.

Also, it will be understood that when an element is referred to as being “connected to,” “coupled to,” or “linked to” another element, these elements can be directly connected or coupled to each other, another intervening element may be present therebetween, or the respective elements may be connected, coupled, or linked to each other through another elements.

Throughout the specification, the expression “A and/or B” means A, B, or A and B, unless otherwise defined. That is, as used herein, the term “and/or” includes any and all combinations of one or more of the associated listed items. The expression “C to D” means C or more and D or less, unless otherwise defined.

As used herein, the terms are for describing embodiments of the present disclosure and are not intended to limit the disclosure.

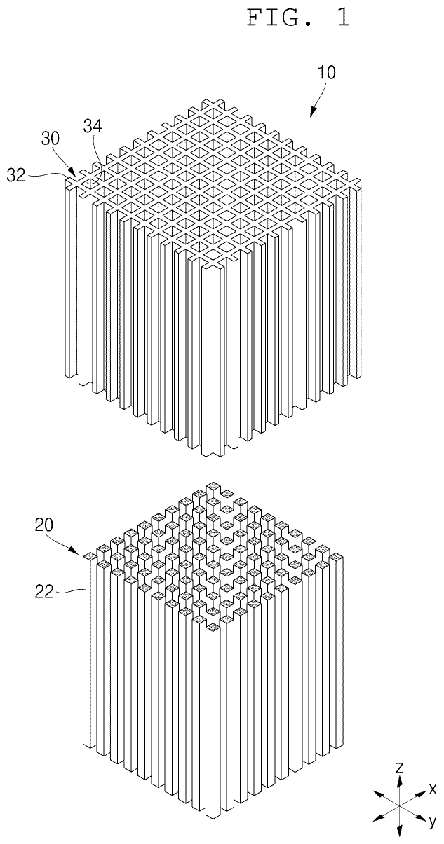

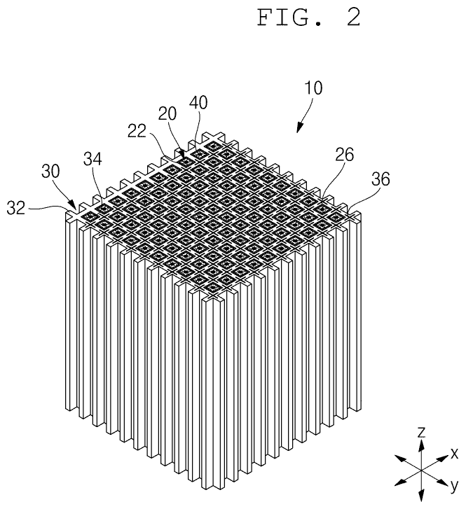

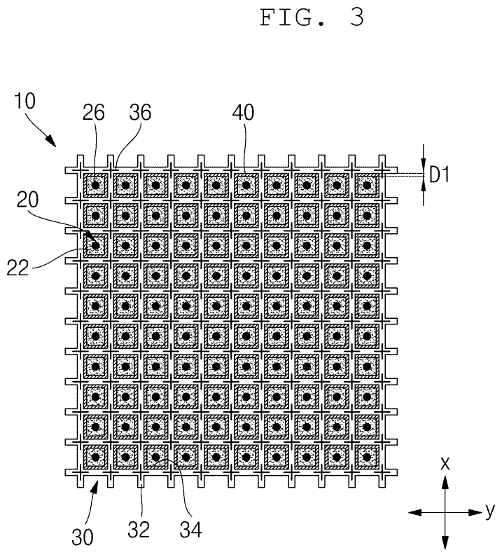

FIG. 1 is an exploded perspective view of an electrode assembly 10 for secondary batteries according to an embodiment of the present disclosure, FIG. 2 is a perspective view of an assembled electrode assembly 10 for secondary batteries according to an embodiment of the present disclosure, and FIG. 3 is a plan view of an electrode assembly 10 for secondary batteries according to an embodiment of the present disclosure. As shown in FIGS. 1 to 3, the electrode assembly 10 for secondary batteries according to an embodiment of the present disclosure may include a first electrode 20, a second electrode 30, and an electrolyte layer 40.

In the present disclosure, a single negative electrode and a single positive electrode may be coupled to each other to form a single cell. Instead of using an existing active material coating method, in the single cell thick active material layers each may be formed in the shape of a column and the active material layers may be engaged with each other.

A negative electrode (or a positive electrode) formed in the shape of a plurality of columns and a positive electrode (or a negative electrode) having a structure corresponding to the plurality of columns may be assembled such that a constant distance is maintained between the electrodes. The space between the electrodes may be filled with a curable electrolyte, such as poly-2-ethyl-oxazoline, to achieve stable electrical connection and physical coupling between the electrodes.

An existing method of assembling electrode plates in a stacked state may have problems such as the occurrence of errors during a process step and difficulty in optimization. In the present disclosure, thick active material layers each may be formed in the shape of a column and may be simply assembled to constitute a single cell. As a result, it is possible to effectively reduce the current density and to maximize process efficiency.

The electrode assembly may be shaped in various patterns and may be flexibly applied to various battery designs through variation of the electrode structure and the electrolyte layer 40.

With the present disclosure, it is possible to overcome the limitations of existing technologies and to implement a high-performance, high-efficiency secondary battery 1 through simple structural design and an advanced assembly process.

The first electrode 20 may include a first current collector 26 and the first active material layer 22, which may be coupled to form a column shape.

In some examples, the first electrode 20 may be formed in the shape of a plurality of columns, which may be arranged at uniform intervals to ensure alignment of the electrode assembly. Each column of the first electrode 20 may have a square or circular section, and the columns may be arranged in a matrix.

The first electrode 20 may extend in a vertical direction (z) and may be inserted into and coupled to a plurality of mounting holes 34 formed on the second electrode 30. Thus, it is possible to maintain an appropriate distance between parts of the electrode, to provide electrical connection stability, and to increase the mechanical strength and thermal stability of the electrode.

The columnar arrangement of the first electrode 20 may provide a uniform current density during charging and discharging and enable efficient electrochemical reaction. This structure may provide for extended battery life and an increased charge rate.

The first current collector 26 may be located in the centers of the columns of the first electrode 20 and may serve to support the first active material layer 22. In some examples, the first current collector 26 may be made of copper, a copper alloy, nickel, a nickel alloy, or a similar metal foil, and may provide excellent electrical conductivity.

The first current collector 26 may have a square section, a cylindrical section, or a polygonal rod shape, and the shape may be selected according to the design requirements of the electrode structure. This column structure may extend in the vertical direction (z) to provide mechanical stability and ease of assembly.

The first active material layer 22 may be fixed to the outside of the first current collector 26 in each of the columns to constitute the first electrode 20. Such a configuration maintains structural integrity that is resistant to heat and stress generated during charging and discharging.

In some examples, the first current collector 26 may be designed in various shapes and sizes so as to be tailored to specific applications and battery design requirements. For example, a cylindrical structure may be suitable for a circular battery, and a square structure may be suitable for a prismatic battery.

The first active material layer 22 may be fixed to the outside of the first current collector 26 in each column, and may be the main component constituting the column shapes. In some examples, the first active material layer 22 may include graphite, carbon, or a combination thereof, and the first current collector 26 may have the property of reversibly intercalating and deintercalating lithium ions.

The first active material layer 22 may have specific physical and chemical properties. For example, the density and thickness of an active material may be adjusted according to the intended use as the density and thickness of the active material affect the capacity of the electrode and the charge and discharge rate.

The first active material layer 22 may be strongly coupled to the first current collector 26, with the first active material layer 22 providing both electrical conductivity and mechanical strength. In some embodiments, a conductive agent and a binder may be further included to improve the electrochemical performance and structural stability of the electrode.

The first active material layer 22 may provide for an electrochemical reaction that occurs during charging and discharging, thereby increasing the energy density and cycle life of the secondary battery 1.

The second electrode 30 may include a second current collector 36 and a second active material layer 32 on the columns of the second current collector 36. The second electrode 30 may be coupled with the first electrode 20 to perform the basic electrochemical reaction of the secondary battery 1. The second electrode 30 may be designed in a columnar shape and may extend in the vertical direction (z) so as to be precisely coupled to the first electrode 20.

In some examples, the second electrode 30 may be formed in a lattice-shaped frame structure that includes a plurality of mounting holes 34 therein. The mounting holes 34 may be formed so as to correspond in position and size to the columns of the first electrode 20, which allows for precise control of insertion and coupling of the first electrode 20.

The lattice structure of the second electrode 30 may maintain a uniform distance between the electrodes and may provide mechanical strength and structural stability in the electrode assembly. This design may increase the reliability of the electrical connection and may minimize the interference between the electrodes, thereby optimizing battery performance.

The second electrode 30 may be modified into various shapes (e.g., a circular shape or a polygonal shape) including a square section. The second electrode 30 may thereby be adjusted according to various battery designs and usage environments. The lattice structure of the second electrode 30 may be made through an electrical discharge machining or ceramic sintering process, which may enable high precision and strength.

The second current collector 36 may be located in the second active material layer 32 and may ensure the electrical connection and mechanical stability of the second electrode 30. The second current collector 36 may have a structure extending in the vertical direction (z), and may have various sectional shapes, such as a cross shape, a square shape, and a circular shape. The second current collector 36 may be the main support for the second electrode 30, which includes a lattice structure, and may be disposed near the apexes of the mounting holes 34 to increase stability in coupling to the first electrode 20.

The second current collector 36 may be made of a highly conductive metal such as copper, aluminum, nickel, or an alloy thereof. These metals may minimize electrical resistance and may improve battery efficiency.

The second active material layer 32 may be fixed to the outside of the second current collector 36, and the second active material layer 32 may be the main component responsible for electrochemical reaction. In some examples, if the second current collector 36 functions as a positive electrode, the second active material layer 32 may include a lithium transition metal oxide such as lithium nickel cobalt manganese oxide or lithium iron phosphate). In another example where the second current collector 36 functions as a negative electrode, the second active material layer 32 may include graphite or carbon. The first active material layer 22 may functions a positive electrode or a negative electrode depending on the polarity of the first current collector 26. If the first current collector 26 constitutes a positive electrode, the first active material layer 22 may include lithium transition metal oxide, and if the first current collector 26 constitutes a negative electrode, the first active material layer 22 may include graphite or carbon. The second active material layer 32 may be strongly coupled to the second current collector 36 to provide mechanical stability and improve the overall durability of the electrode structure.

The thickness and composition of the second active material layer 32 may be adjusted according to a specific purpose, thereby providing for the capacity, charge and discharge rate, and cycle life needed for a particular battery.

The mounting holes 34 may be formed so as to receive the columns of the first electrode 20 and may be designed with precise dimensions and arrangements. The mounting holes 34 may have a square sectional shape, a circular sectional shape, or any other polygonal sectional shape, and the mounting holes 34 may be formed so as to engage precisely with the columns of the first electrode 20. The arrangement of the mounting holes 34 may ensure the alignment between the first electrode 20 and the second electrode 30 and may contribute to improving the reliability of electrical connection.

The mounting holes 34 may be formed with high precision through the electrical discharge machining or ceramic sintering process, thereby minimizing interference between the electrodes and improving assembly efficiency.

The distance D1 (e.g., 0.1 mm to 3 mm) set between the first electrode 20 and the second electrode 30 may be designed to prevent physical interference between the electrodes and to ensure electrochemical connection between the electrodes. This distance may maintain a uniform current density between the electrodes and may provide space for efficient heat dissipation during the charging and discharging process. The set distance D1 may be filled with a curable electrolyte, whereby the electrolyte layer 40 may be formed. This layer may support smooth migration of lithium ions while maintaining insulation between the electrodes.

The electrolyte layer 40 may be disposed between the first electrode 20 and the second electrode 30 to support the electrochemical reaction of the secondary battery 1 and to maintain the insulation between the electrodes. The electrolyte layer 40 according to the present disclosure may include a curable electrolyte, and the electrolyte layer may have various shapes and physical properties depending on the structure and functional requirements of the electrode assembly.

The electrolyte layer 40 may be made of a curable electrolyte including an oxazoline-based compound. For example, a polymer such as poly-2-ethyl-oxazoline may be used. This polymer may improve the physical stability and electrochemical properties of the electrolyte layer 40. The electrolyte layer 40 may further include a lithium salt to increase ionic conductivity and to support electrochemical efficiency and uniformity of current distribution. Suitable lithium salts include LiPF₆, LiBF₄, and LiTFSI.

The electrolyte layer 40 may be in a liquid state before curing such that the space between the electrodes can be uniformly filled with the electrolyte layer, and the electrolyte layer 40 may turn to a solid state through a curing process. The ease of filling in the liquid state and the mechanical stability in the solid state are the main advantages of the electrolyte layer 40, which may simplify the manufacturing process and may enhance the structural durability of a finished electrode assembly.

The shape and thickness of the electrolyte layer 40 may be adjusted according to the distance between the electrodes and the battery design. In some embodiments, the electrolyte layer 40 may be uniformly formed within the distance between the electrodes (which may be 0.1 mm to 3 mm), and the thickness of the electrolyte layer 40 may be adjusted within a range of 0.1 mm to 0.5 mm to optimize ionic conductivity and insulation.

The electrolyte layer 40 may further include an ion-conductive additive, a heat-resistant additive, and a dispersion stabilizer in order to improve performance. These additives may help improve the physical and chemical properties of the electrolyte layer 40 to maintain stable battery performance even after prolonged use.

The electrolyte layer 40 may prevent physical contact between the electrodes in the electrode assembly, preventing electrical short circuiting and providing a migration path for lithium ions to facilitate electrochemical reaction. The electrolyte layer 40 may dissipate heat generated during charging and discharging to prevent deterioration of battery performance and to provide a stable operating environment during long-term use.

The electrolyte layer 40 according to the present disclosure may be a hybrid electrolyte layer 40 including a combination of a liquid electrolyte and a solid electrolyte. As such, the electrolyte layer 40 may be highly compatible with existing manufacturing processes. This design may reduce manufacturing costs, may provide process flexibility suitable for mass production, and may satisfy various performance targets such as capacity, charge and discharge rate, and cycle life of the battery.

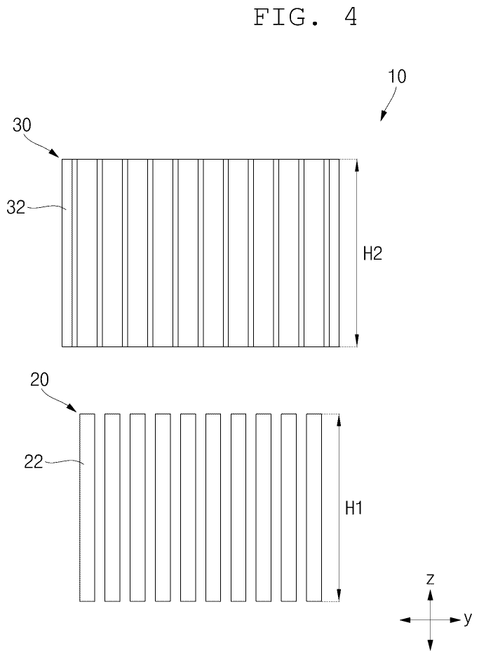

FIG. 4 is a front view showing an exploded state of the electrode assembly 10 for secondary batteries according to an embodiment of the present disclosure. As shown in FIG. 4, the heights (z direction) of the first electrode 20 and the second electrode 30 may be the same, or the heights may be slightly different as needed. If the height of the first electrode 20 in the vertical direction (z) is defined as a first height H1 and the height of the second electrode 30 in the vertical direction (z) is defined as a second height H2, each of the first height H1 and the second height H2 may be 1 mm to 10 cm. These heights may allow the electrode assembly to be used in secondary battery designs of various sizes, harmoniously optimizing battery capacity and space efficiency.

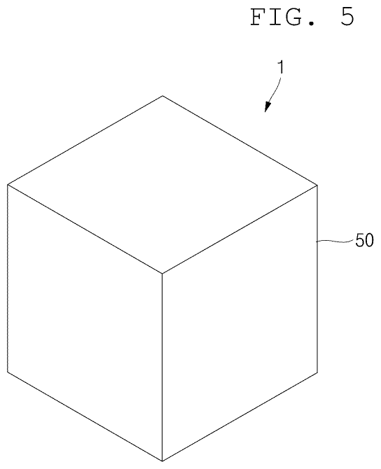

FIG. 5 is a perspective view showing a secondary battery 1 according to an embodiment of the present disclosure. As shown in FIG. 5, an electrode assembly for secondary batteries may be received in a case 50 that protects the electrode assembly from external impact and environmental factors.

Although not shown in the figure, a positive electrode terminal and a negative electrode terminal may be provided outside the case 50, and the terminals may be electrically connected to the electrode assembly 10 for secondary batteries. The positive electrode terminal and the negative electrode terminal may be electrically connected to an external circuit to facilitate a charging and discharging process.

The case 50 may be formed in various shapes, such as a cylindrical shape, a prismatic shape, and a pouch shape. In the present disclosure, a prismatic battery will be described as an example. The prismatic case 50 may be suitable for high-density battery design because space utilization is high and the disposition and sealing of the electrode assembly are easy. However, the present disclosure is not limited to a prismatic case, and cases having different shapes may be used for various application environments.

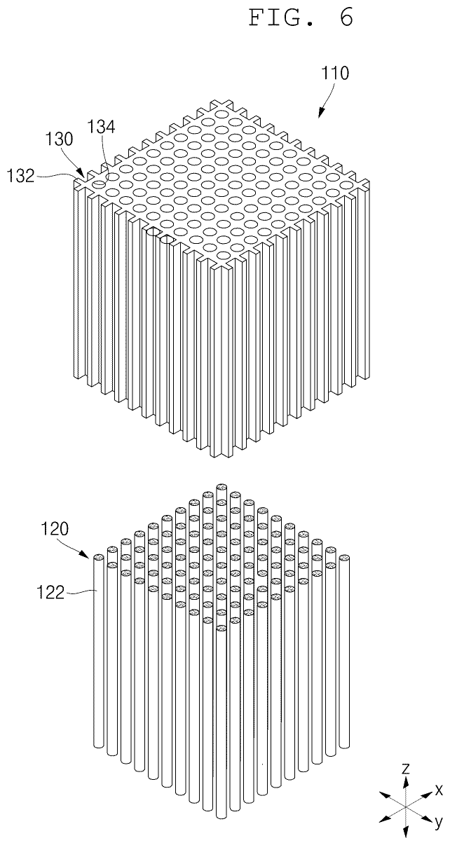

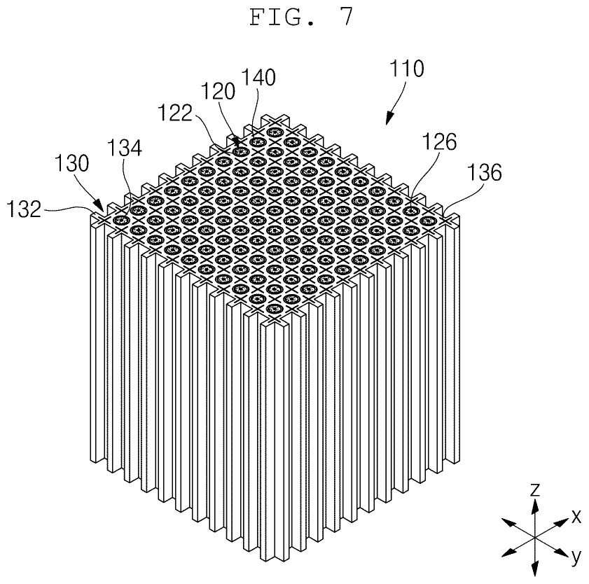

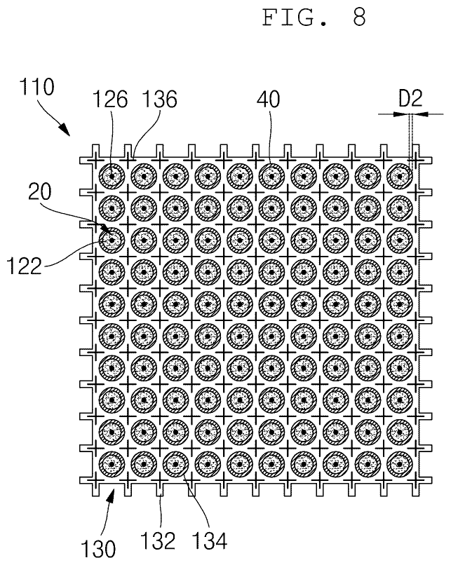

FIG. 6 is an exploded perspective view of an electrode assembly 110 for secondary batteries according to a further embodiment of the present disclosure, FIG. 7 is an assembled perspective view of the electrode assembly 110 for secondary batteries according to the further embodiment, and FIG. 8 is a plan view of the electrode assembly 110 for secondary batteries according to the further embodiment of the present disclosure. As shown in FIGS. 6 to 8, the electrode assembly 110 for secondary batteries may include a first electrode 120, a second electrode 130, and an electrolyte layer 140.

The electrode assembly 110 for secondary batteries a is identical or similar in configuration to the electrode assembly according to the previous embodiment of the present disclosure except that the first electrode 120 and the mounting holes 134 have different shapes. In the present embodiment, therefore, a description of differences in shape will be described, and reference may be made to the previous embodiment of the present disclosure for description of other features.

The first electrode 120 may include a first current collector 126 and a first active material layer 122. The first current collector 126 may be located in the center of the first electrode 120 and may support the first active material layer 122. In the present embodiment, the first electrode 120 may be formed in the shape of a plurality of cylinders, and the cylinders may be arranged at uniform intervals. The cylinders may extend in the vertical direction (z) and may be inserted into and coupled to mounting holes 134 of the second electrode 130.

The first current collector 126 may be disposed inside the first active material layer 122 and may be formed in a cylindrical shape extending in the vertical direction (z). The first current collector 126 may include a plurality of cylinders, and the first active material layer 122 may be fixed to the outside of each thereof. More specifically, the first active material layer 122 may be formed along an outer surface of the first current collector 126 and may provide structural stability and electrochemical performance of the electrode assembly.

The plurality of cylinders of the first electrode 120 may be disposed in a matrix array, and each cylinder may be coupled to a corresponding one of the mounting holes 134 of the second electrode 130. The mounting holes 134 of the second electrode 130 may correspond to the cylinders of the first electrode 120, and the mounting holes 134 may be designed such that a uniform distance is maintained between the electrodes if the cylinders of the first electrode 120 are coupled to the mounting holes 134 of the second electrode 130. This configuration may prevent electrical short circuiting in the electrode assembly and may provide space for formation of the electrolyte layer 140.

The first active material layer 122 may be formed in the shape of a cylinder, may be fixed to the outside of the first current collector 126, and may include an active material (e.g., graphite or carbon) that enables reversible migration of lithium ions. This configuration may maximize the electrochemical performance of the electrode assembly and may improve charging and discharging efficiency of the secondary battery 1.

The electrode assembly 110 for secondary batteries according may have a cylindrical structure, which may accommodate various battery design requirements and implement high-performance batteries through a simpler manufacturing process than conventional designs.

The second electrode 130 may include a second current collector 136 and a second active material layer 132. Unlike the rectangular mounting holes 134 described above, the second electrode 130 may include mounting holes 134 each formed in the shape of a circular hole corresponding to the cylindrical shape of the first electrode 120. The mounting holes 134 may be located in the second electrode 130 and may be configured to allow the plurality of cylinders of the first electrode 120 to be inserted thereinto.

The second active material layer 132 may be fixed to the outside of the second current collector 136 to support electrochemical reaction, and the second active material layer 132 may be continuously formed along the peripheries of the circular hole-shaped mounting holes 134. The second active material layer 132 may include various active materials (e.g., lithium metal oxide), and may interact with the first active material layer 122 of the first electrode 120 to facilitate the flow of current during charging and discharging.

The second current collector 136 may be located in the second active material layer 132, and the second current collector 136 may provide mechanical stability and electrical conductivity to the second electrode 130. The second current collector 136 may be disposed along the circumference of the circular mounting hole 134, and the second current collector 136 may reinforce the shape of the mounting hole 134 as needed. The second current collector 136 may be made of a metal, and a conductive metal such as copper, aluminum, or nickel may be used.

The electrolyte layer 140 may be formed between the first electrode 120 and the second electrode 130, with the electrolyte layer 140 filling the space between the first electrode 120 and the second electrode 130 while maintaining a set distance D2. The set distance D2 may prevent physical contact between the electrodes and may provide a minimum space to prevent electrical short circuiting. In the present embodiment, the distance between the electrodes may be 0.1 mm to 3 mm, and the electrolyte layer 140 may be uniformly formed in this space.

The electrolyte layer 140 may be made of a curable electrolyte and may include an oxazoline-based compound (poly-2-ethyl-oxazoline) and a lithium salt (LiPF₆ or LiTFSI) to support migration of lithium ions. The space between the electrodes may be initially filled with the electrolyte layer 140 in a liquid state, and the electrolyte layer 140 may turn to a solid state through a curing process. This design may contribute to ensuring long-term durability and electrical stability of the electrode assembly.

The structure of the second electrode 130 including the circular mounting holes 134 may be configured to be precisely coupled to the cylinders of the first electrode 120, thereby simplifying the assembly process and maintaining consistency in battery performance. This structure may be applied to various types of secondary batteries, and the structure may be suitable for high-density battery designs using a cylinder array.

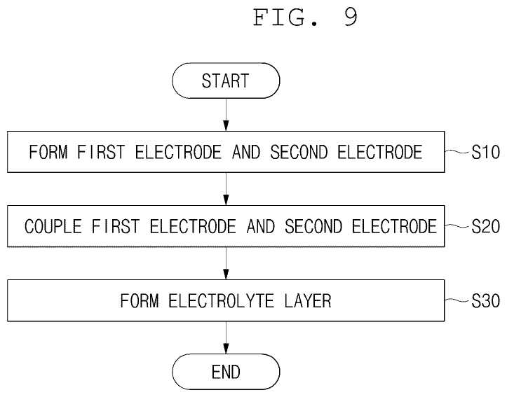

FIG. 9 is a flowchart showing a method of manufacturing an electrode assembly 10 for secondary batteries according to an embodiment of the present disclosure. As shown in FIG. 9, the method of manufacturing the electrode assembly 10 for secondary batteries according to the embodiment of the present disclosure may include a step S10 of forming a first electrode 20 and a second electrode 30.

In the step of forming the first electrode 20, a first active material layer 22 may be formed in the shape columns on the outside of a first current collector 26 to make a first electrode 20 including a plurality of columns. In some examples, the first electrode 20 may include a plurality of cylinders arranged at uniform intervals, wherein the cylinders may extend in the vertical direction (z).

In the step of forming the second electrode 30, a second active material layer 32 may be formed in the shape of a column on the outside of a second current collector 36 to manufacture a second electrode 30 including a single column. The second electrode 30 may include the single column in the shape of a lattice and may be provided with a plurality of mounting holes 34 into which the columns of the first electrode 20 are inserted. The step of forming the first electrode 20 and the step of forming the second electrode 30 may be performed simultaneously, or the first electrode 20 may be formed and then the second electrode 30 may be manufactured or vice versa.

In some examples, each of the first electrode 20 and the second electrode 30 may be formed in the shape of a column through electrical discharge machining. Electrical discharge machining is technology for implementing precise and complex shapes in metal working, in which a metal may be removed by melting or vaporizing the metal using heat energy generated by sparks between a positive electrode and a negative electrode.

Electrical discharge machining may make parts having complex shapes with high precision, in which voltage may be applied to a metal to precisely shape the metal into the shape of a column. This may allow the mass production of complex structures, which is difficult to implement using existing manufacturing processes. For example, a plurality of columns may be formed as the first electrode 20 or plurality of mounting holes 34 may be precisely formed in the second electrode 30 through electrical discharge machining.

Electrical discharge machining may be used to form recesses in the surface of an electrode plate or to shape the electrode plate so as to have a 3D structure. And the columnar electrode may be assembled using a curable electrolyte (poly-2-ethyl-oxazoline).

In some examples, each of the first electrode 20 and the second electrode 30 may be formed in the shape of a column through a ceramic sintering process. Ceramic sintering is technology that promotes bonding between active material particles at high temperatures to form a high-density columnar structure. This process may be advantageous for implementing a thick active material layer suitable for solid-state electrolytes and all-solid-state batteries.

If a dry process is used, an active material, a conductive agent, and a binder may be applied directly to a current collector without a solvent, simplifying the manufacturing process. This method may eliminate processes such as solvent treatment and drying, thereby increasing efficiency in terms of time, physical labor, and cost. The ceramic sintering process may control the thickness and uniformity of the active material layer, which may be advantageous for implementing a high-performance electrode structure.

This manufacturing method may be adopted for complex battery design requirements, and may provide both production efficiency and battery performance.

A step S20 of coupling the first electrode 20 and the second electrode 30 to each other may include a process of inserting each of the columns of the first electrode 20 into corresponding mounting holes 34 of the second electrode 30 so as to be physically coupled to each other. Each of the columns of the first electrode 20 may be disposed in a corresponding one of the mounting holes 34 of the second electrode 30 such that a set distance D1 is maintained between the first electrode 20 and the second electrode 30.

In an electrode assembly for secondary batteries, each of the columns of the first electrode 20 may engage with a corresponding one of the mounting holes 34 of the second electrode 30. For example, each of the columns of the first electrode 20 may be formed so as to correspond in position and size to a corresponding one of the mounting holes 34 of the second electrode 30, thereby facilitating mechanical alignment and ensuring uniformity in distance between the electrodes during assembly of the electrode assembly 10 for secondary batteries.

In some examples, the columns of the first electrode 20 and the mounting holes 34 of the second electrode 30 may be coupled to each other. For example, an outer surface of the column and an inner surface of the mounting hole may be in tight contact with each other. This may reduce errors during an electrode assembly process and may improve the stability of contact between the electrodes.

The structure in which the column of the first electrode 20 and the mounting hole 34 of the second electrode 30 engage with each other may help to increase the uniformity in flow of current during the charging and discharging process because the uniformity in distance between the electrodes is secured.

The set distance D1 may be, for example, 0.1 mm to 3 mm. The distance between the electrodes may determine the uniformity and performance of an electrolyte layer 40 that fills the space between the electrodes in a subsequent step.

The columns of the first electrode 20 and the mounting holes 34 of the second electrode 30 may be maintained at the set distance D1, and precise positioning between the columns and the mounting holes 34 may be performed. This design may prevent direct contact between the electrodes, thereby preventing short circuiting, and may provide space for the electrolyte to fill the set distance D1.

A step S30 of forming an electrolyte layer 40 may include a process of filling the set distance D1 between the first electrode 20 and the second electrode 30 with a curable electrolyte and curing the same. The electrolyte for filling may be initially provided in a liquid state, and the electrolyte may turn to a solid electrolyte layer 40 through a curing process.

The space between the first electrode 20 and the second electrode 30 may be uniformly filled with the electrolyte layer 40 to support smooth migration of lithium ions and to serve as an insulator that prevents short circuit between the electrodes. In some examples, the electrolyte may include an oxazoline-based compound (poly-2-ethyl-oxazoline) and a lithium salt (LiPF₆ or LiTFSI). This configuration may increase the physical and chemical stabilities of the electrolyte layer 40, thereby improving the long-term reliability and performance of the battery.

The coupling process and the process of forming the electrolyte layer 40 may be a part of the process of manufacturing a secondary battery assembly, and these processes may simultaneously secure the electrochemical properties and mechanical stability of the battery.

The electrode assembly 10 according to the present disclosure will be described in more detail.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c}(0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≤0.1); LiaMn_{1-g}GgPO4(0.90≤a≤1.8, 0≤g≤0.5); Li_{(3-f)}Fe₂(PO₄)₃(0≤f≤2); LiₐFePO₄(0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt % , respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

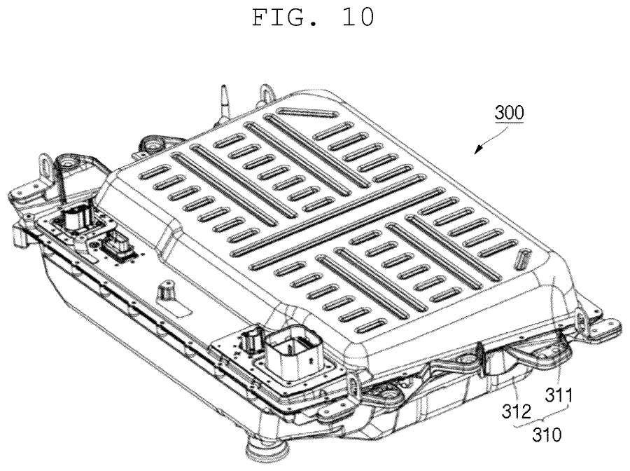

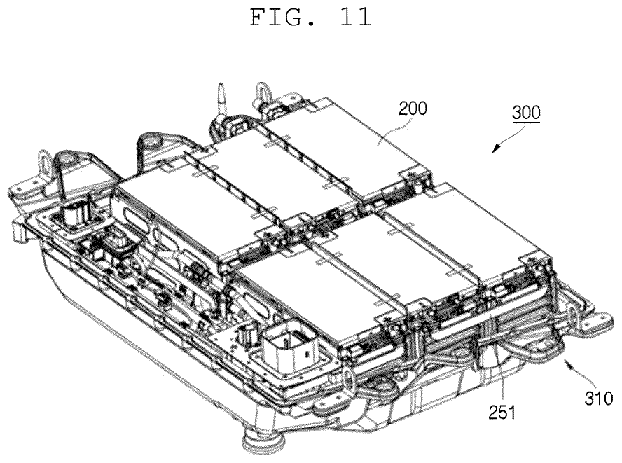

The batteries according to the above-described embodiments may be used to manufacture a battery pack. FIGS. 10 and 11 are perspective views showing a battery pack including the exemplary secondary battery according to the present disclosure. Referring to FIGS. 10 and 11, the battery pack 300 may include a plurality of battery modules 200 and a housing 310 to accommodate the plurality of battery modules 200. For example, the housing 310 may comprise a first and a second housing 311, 312 that are coupled in facing directions with the plurality of battery modules 200 interposed between them. The plurality of battery modules 210 can be electrically connected to each other using a bus bar 251, and the plurality of battery modules 200 can be electrically connected in series/parallel or a mixed series-parallel manner to obtain the required electrical output. In the drawings, for the sake of convenience, components such as bus bars, cooling units, and external terminals for the electrical connection of battery cells are omitted. In some embodiments, the battery pack 300 can be mounted on a vehicle. The vehicle may be, for example, an electric vehicle, a hybrid vehicle, or a plug-in hybrid vehicle. The vehicle can include both four-wheel and two-wheel vehicles.

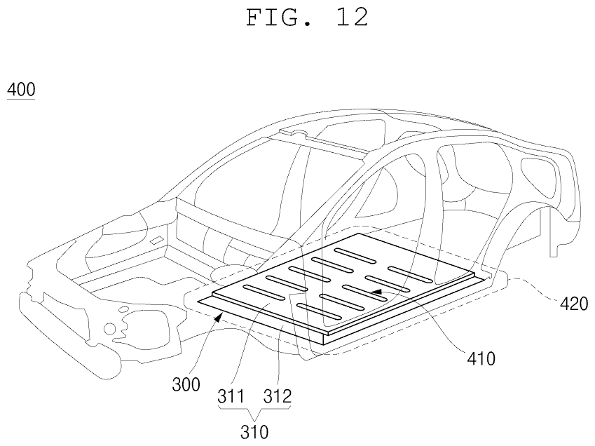

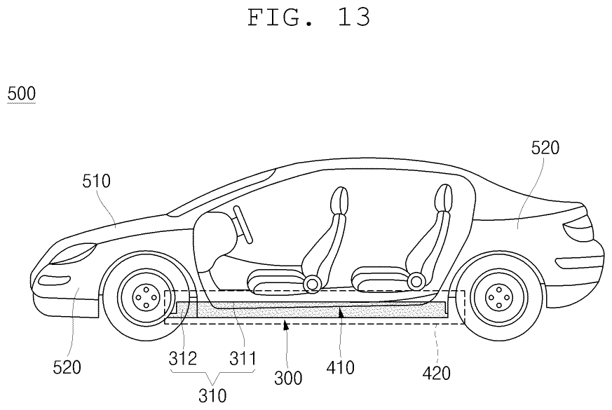

FIGS. 12 and 13 are, respectively, a perspective view and a side view showing vehicles 400 and 500 including the exemplary battery pack 300 according to the present disclosure.

In FIG. 12, the battery pack 300 may include a battery pack cover 311, which is part of the vehicle underbody 410 and may correspond to the first housing, and a pack frame 312, which is placed beneath the vehicle underbody 410 and may correspond to the second housing. The battery pack cover 311 and pack frame 312 may be structurally integrated with the vehicle floor 420. The vehicle underbody 410 separates the interior and exterior of the vehicle, and the pack frame 312 may be positioned outside the vehicle.

As shown in FIG. 13, the vehicle 500 can be assembled with additional components such as a hood 510 at the front of the vehicle body 400 and fenders 520 located at the front and rear of the vehicle. The vehicle 500 includes the battery pack 300 comprising the battery pack cover 311 and the pack frame 312, and the battery pack 300 can be coupled to the vehicle body part 400.

As is apparent from the above description, according to embodiments of the present disclosure, it is possible to facilitate maintain distance and alignment between electrodes by an electrode structure designed in the shape of a plurality of columns and an electrode assembly in which the electrodes are coupled to each other by engagement, thereby improving the reliability of a manufacturing process.

It is possible to maintain a uniform current density between the electrodes and to maximize the efficiency of electrical connections using electrical discharge machining and a curable electrolyte, thereby significantly improving the charging and discharging performance and battery life.

A dry method that excludes a solvent may be adopted in an electrode assembly process, thereby reducing manufacturing costs and simplifying the process.

However, the effects achievable through the present invention are not limited to those described above, and other technical effects not mentioned can be clearly understood by those skilled in the art from the description of the invention provided above.

Although a few embodiments of the present disclosure have been shown and described, it would be appreciated by those skilled in the art that various changes and modifications may be made in this embodiment without departing from the principles and technical idea of the disclosure.

What is claimed is:

1. An electrode assembly for secondary batteries, the electrode assembly comprising:
a first electrode comprising a first current collector and a first active material layer provided on an outside of the first current collector, the first electrode being a columnar shape;
a second electrode comprising a second current collector and a second active material layer provided on an outside of the second current collector, the second electrode being provided with a mounting hole configured to receive the first electrode therein, the second electrode extending to a length corresponding to the first electrode; and
an electrolyte layer disposed between the first electrode and the second electrode, with the electrolyte layer comprising a curable electrolyte.

2. The electrode assembly as claimed in claim 1, wherein the first electrode is one of a positive electrode and a negative electrode, and
wherein the second electrode is one of a positive electrode and a negative electrode that is opposite to the first electrode.

3. The electrode assembly as claimed in claim 1, wherein the first electrode and the second electrode are coupled to each other with a set distance being maintained between the first electrode and the second electrode.

4. The electrode assembly as claimed in claim 3, wherein the set distance is 0.1 mm to 3 mm.

5. The electrode assembly as claimed in claim 1, wherein the first electrode and the second electrode have the same height.

6. The electrode assembly as claimed in claim 1, wherein each of the first electrode and the second electrode have a height of 1 mm to 10 cm.

7. The electrode assembly as claimed in claim 1, wherein the electrolyte layer is formed from a curable electrolyte comprising an oxazoline-based material.

8. The electrode assembly as claimed in claim 7, wherein the electrolyte layer further comprises a lithium salt.

9. The electrode assembly as claimed in claim 1, wherein the electrolyte layer is in a liquid state before curing and turns to a solid state during a curing process.

10. The electrode assembly as claimed in claim 1, wherein the first electrode comprises a plurality of columns arranged at uniform intervals.

11. The electrode assembly as claimed in claim 1, wherein the first electrode comprises a plurality of prisms arranged in a matrix form.

12. The electrode assembly as claimed in claim 1, wherein the second electrode comprises a single column formed in a lattice shape, and the mounting hole is provided in the second electrode.

13. The electrode assembly as claimed in claim 12, wherein the second electrode includes a plurality of the mounting hole, and each of a plurality of columns of the first electrode is inserted into one of the mounting holes.

14. A method of manufacturing an electrode assembly for secondary batteries, the method comprising:
forming a first electrode comprising a first active material layer provided on an outside of a first current collector, the first electrode being a formed as a plurality of columns;
forming a second electrode comprising a second active material layer provided on an outside of a second current collector, the second current collector being a columnar shape, with a plurality of holes being formed in the second electrode;
inserting each of the columns of the first electrode into a corresponding one of the mounting holes of the second electrode to couple the first electrode and the second electrode to each other; and
filling a space between the first electrode and the second electrode with a curable electrolyte to form an electrolyte layer.

15. The method as claimed in claim 14, wherein each of the first electrode and the second electrode is formed by electrical discharge machining.

16. The method as claimed in claim 14, wherein each of the first electrode and the second electrode is formed by a ceramic sintering process.

17. The method as claimed in claim 14, wherein the columns of the first electrode are arranged at uniform intervals in the second electrode.

18. The method as claimed in claim 14, wherein the second electrode comprises a single column formed in a lattice shape, and the mounting holes are provided in the second electrode.

19. The method as claimed in claim 14, wherein each of the columns of the first electrode and a corresponding one of the mounting holes of the second electrode engage with each other.

20. The method as claimed in claim 14, wherein the electrolyte layer comprises a curable electrolyte.
